(19) United States
(12) Patent Application Publication
(10) Pub. No.: US 2026/0015707 A1
(43) Pub. Date: Jan. 15, 2026

(54) PROCESS FOR THE PROTECTION OF MECHANICAL ELEMENTS OF WELDING ASSEMBLIES AGAINST WELD RESIDUES AND SPATTER AND COATED MECHANICAL ELEMENT OF WELDING ASSEMBLIES

(71) Applicant: ATOP S.P.A., Barberino Tavarnelle (IT)

(72) Inventors: Rubino CORBINELLI, Poggibonsi, Frazione Staggia Senese (IT); Davide CHESI, Certaldo (IT); Daniele NOCCIOLINI, Firenze (IT)

(21) Appl. No.: 18/992,295

(22) PCT Filed: Jul. 6, 2023
(86) PCT No.: PCT/EP2023/068735

§ 371 Date: Jan. 8, 2025

(30) Foreign Application Priority Data
Jul. 13, 2022 (IT) 102022000014680

(51) Int. Cl. C23C 4/134; B23K 37/04; C23C 4/08; C25D 11/08

(52) U.S. Cl. CPC C23C 4/134; B23K 37/0435; C23C 4/08; C25D 11/08

(57) ABSTRACT

A process for protection of mechanical elements of welding assemblies against weld residues and spatter, for mechanical elements designed to hold metallic components to be welded together, the process comprises the steps of: applying an aluminum powder coating on surfaces of the mechanical elements of the welding assemblies to be protected and using such mechanical elements provided with such coating, to keep at least two metallic components together so that they are reciprocally welded.

The present invention relates to a process for the protection of mechanical elements of welding assemblies against weld residues and spatter by means of a coating and an associated coated mechanical element of welding assemblies (i.e. also defining a protective coating for mechanical elements of welding assemblies).

Weld spatter is an extremely negative phenomenon that accompanies all welding processes: weld spatter is formed from droplets of molten metal (the case of molten copper is of particular interest), or in some cases also from nonmetallic material, which can be produced during a welding process.

The droplets of hot material can be ejected as spatter from the welding, and strike areas that are adjacent to the welding of the material to be welded, mechanical elements that hold the parts to be welded, or another surrounding area. As they cool, they form small, generally round pellets of material where they landed.

The lifetime of the mechanical elements of laser welders is generally limited by the adhesion of spatter and of particles of molten metal (the case of molten copper is of particular interest) which become attached to the surfaces and are difficult to remove.

These deposits are problematic for two reasons: they render the mechanical elements unusable within a short time, especially if the components to be welded are not perfectly clean or if the welding parameters are particularly aggressive, so increasing the production of spatter; they can alter the geometry and the color of the mechanical elements, to the point where they create problems for any vision assembly fitted to the welder (the function of which is to control and check the quality of the welds performed, taking advantage of the contrast of the welds with respect to the mechanical elements arranged close by).

As said, a buildup of weld spatter on mechanical elements such as grippers, clamps and supporting elements, in addition to negatively altering their appearance, can lead over time to a deterioration of functionality, to the point of rendering them incapable of performing their function.

The use is known of protective screens that can be periodically replaced, but this technical solution is not the most indicated for automatic machines, since it implies the introduction of periodic maintenance operations that require the shutdown of the plant and generate costs that can be considerable.

In some cases, it is possible to use mechanical elements made of materials that have a poor compatibility with molten metal (the case of molten copper is of particular interest) that generates the spatter, so that the spatter does not adhere to their surface.

Unfortunately, however, this strategy is not always feasible because in many cases it is essential that the mechanical elements (in particular grippers, clamps and similar components designed to hold the parts to be welded) shall not undergo degradation and/or alterations in shape and dimensions and/or a softening even if brought to high temperatures (in particular to temperatures close to the melting temperature of the metal to be welded).

The aim of the present invention is to solve the above mentioned drawbacks, by providing a process for the protection of mechanical elements of welding assemblies against weld residues and spatter that makes it possible to avoid frequent maintenance operations that would require a machine shutdown.

Within this aim, an object of the invention is to provide a process for the protection of mechanical elements of welding assemblies against weld residues and spatter that makes it possible to use mechanical elements constituted by materials of high mechanical strength and high melting and softening temperatures (higher than or equal to that of the components to be welded).

Another object of the invention is to provide a process for the protection of mechanical elements of welding assemblies against weld residues and spatter that is adapted to provide a coating that ensures that the mechanical element that comprises it maintains dimensions that are substantially similar to the initial ones, even after the deposition of such coating.

Another object of the invention is to provide a process for the protection of mechanical elements of welding assemblies against weld residues and spatter that increases the service lifetime of the mechanical elements that comprise it.

Another object of the invention is to provide a coating for the protection of mechanical elements of welding assemblies against weld residues and spatter that minimizes the maintenance interventions on the mechanical elements that comprise it.

Another object of the invention is to provide a coating for the protection of mechanical elements of welding assemblies against weld residues and spatter that ensures an excellent quality of the welds performed.

Another object of the present invention is to provide a coating for the protection of mechanical elements against weld residues and spatter and an associated coating for the protection of mechanical elements of welding assemblies that is of low cost, easily and practically implemented, and safe in use.

This aim and these and other objects that will become more apparent hereinafter, are achieved by a process for the protection of mechanical elements of welding assemblies against weld residues and spatter, for mechanical elements designed to hold metallic components to be welded together, characterized in that it comprises the steps of:
aluminum powder deposition on surfaces of the mechanical elements of said welding assemblies to be protected so as to obtain a coating on said mechanical elements;
use of said mechanical elements provided with said coating, in welding operation, wherein said coated mechanical elements hold metallic components together so that they are welded to each other.

Such aim and such objects are also achieved by a coated mechanical element for holding metallic components to be subjected to welding, said element comprising a surface, which is at least partially coated, characterized in that said coating is constituted by aluminum powder deposited on said surface so as to create a protection of the mechanical element against weld residues and spatter.

Further characteristics and advantages of the invention will become better apparent from the detailed description that follows of a preferred, but not exclusive, embodiment of the coating for the protection of mechanical elements of welding assemblies against weld residues and spatter, which is illustrated by way of non-limiting example in the accompanying drawings wherein:

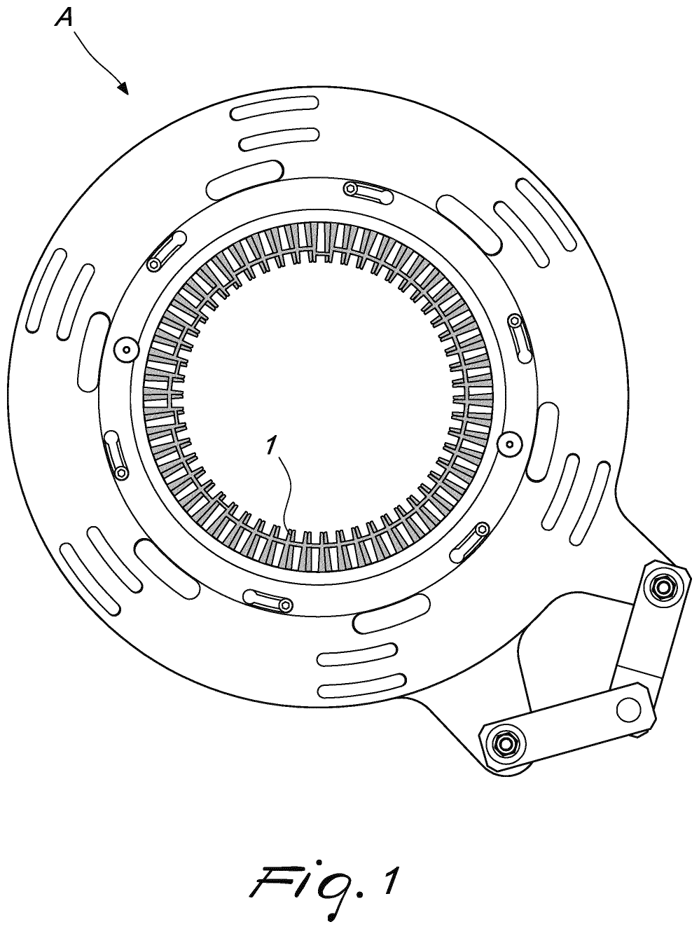

FIG. 1 is a schematic front elevation view of a first embodiment of a mechanical element (in particular a gripping tool) of a welding assembly, provided with the protective coating according to the invention;

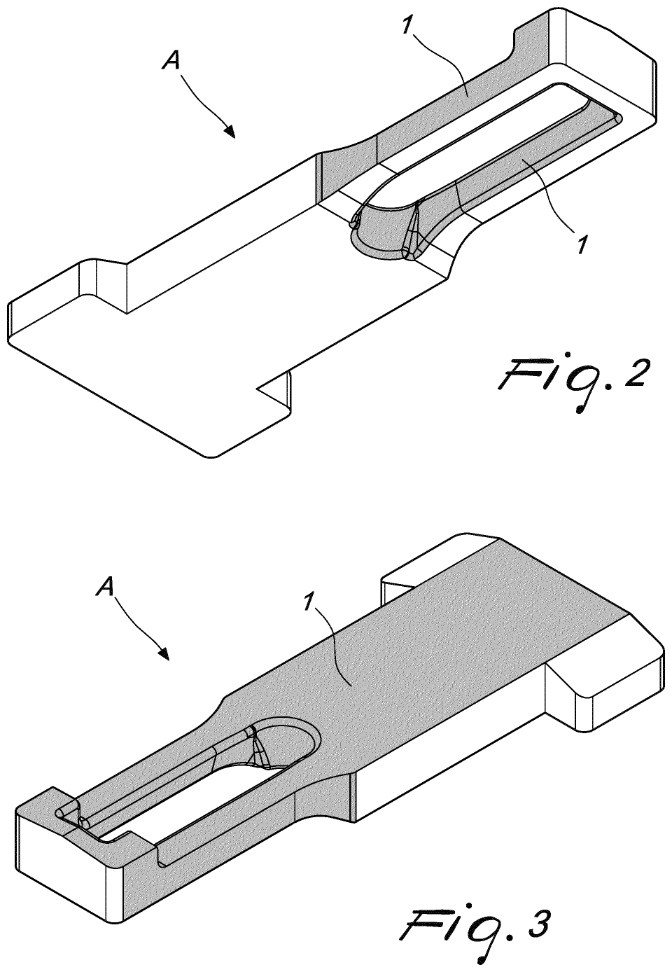

FIG. 2 is a schematic perspective view from below of a second embodiment of a mechanical element (in particular a gripping tool) of a welding assembly, provided with the protective coating according to the invention;

FIG. 3 is a schematic perspective view from above of the mechanical element of FIG. 2;

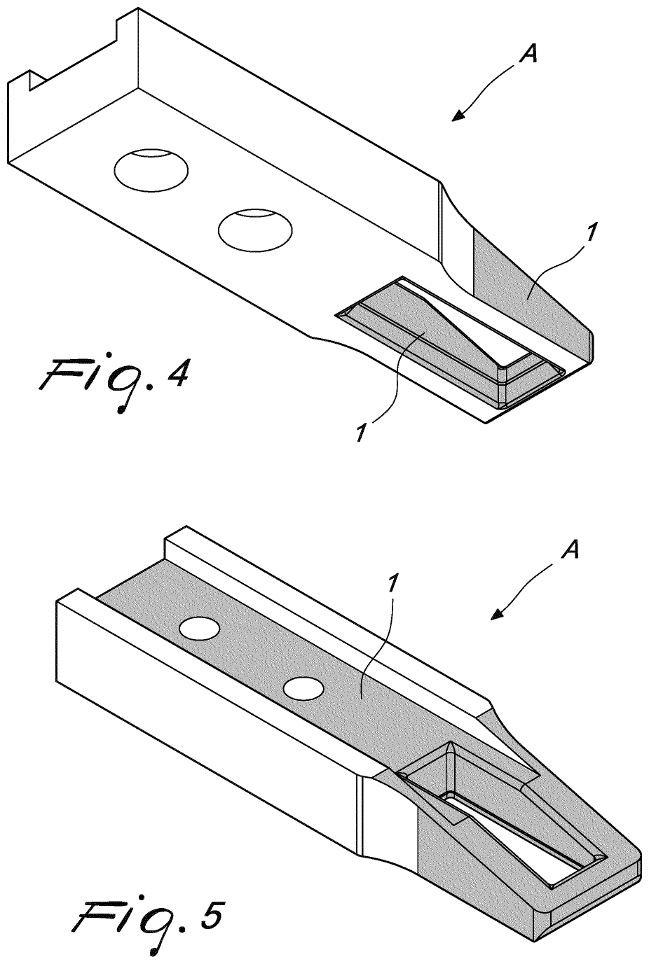

FIG. 4 is a schematic perspective view from below of a third embodiment of a mechanical element (in particular a gripping tool) of a welding assembly, provided with the protective coating according to the invention;

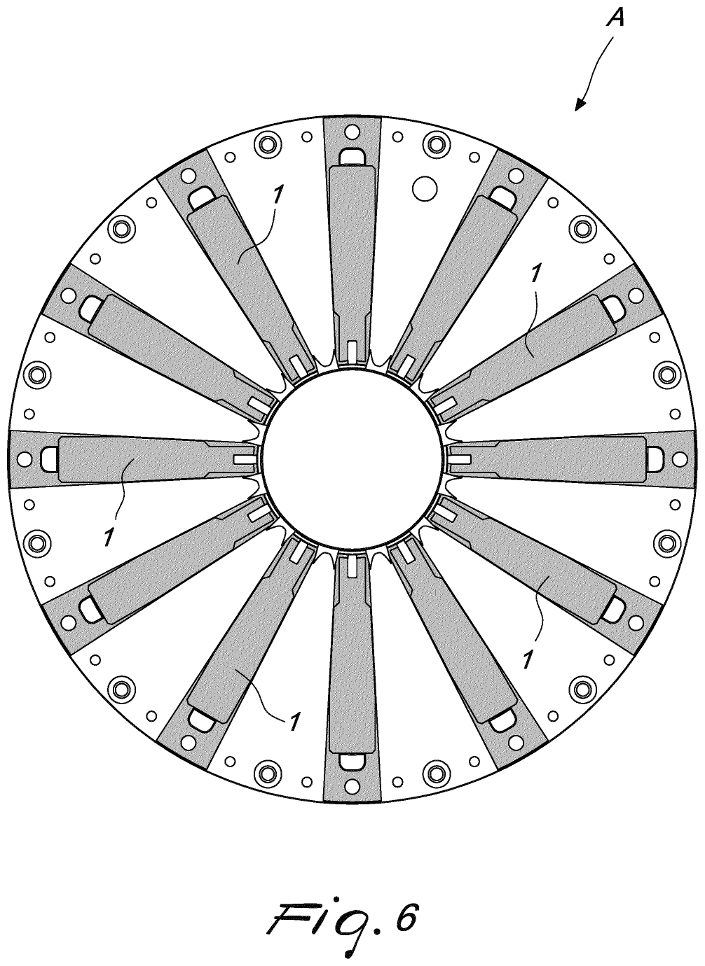

FIG. 5 is a schematic perspective view from above of the mechanical element of FIG. 4;

FIG. 6 is a schematic front elevation view of a fourth embodiment of a mechanical element (in particular a gripping tool) of a welding assembly, provided with the protective coating according to the invention;

FIG. 7 is a schematic perspective view from below of a fifth embodiment of a mechanical element (in particular a gripping tool) of a welding assembly, provided with the protective coating according to the invention;

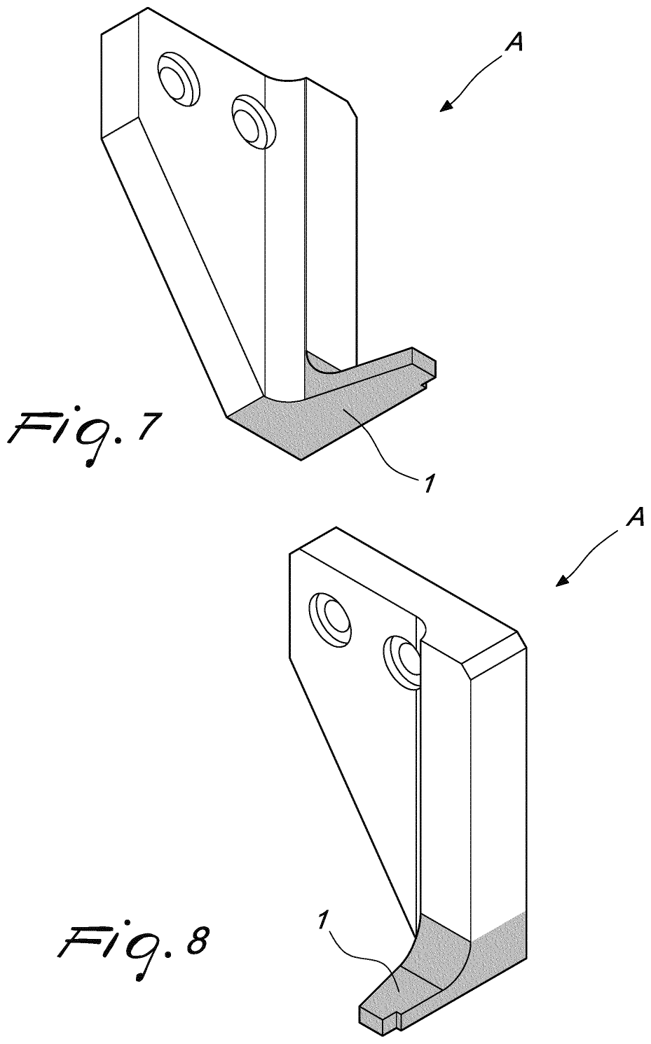

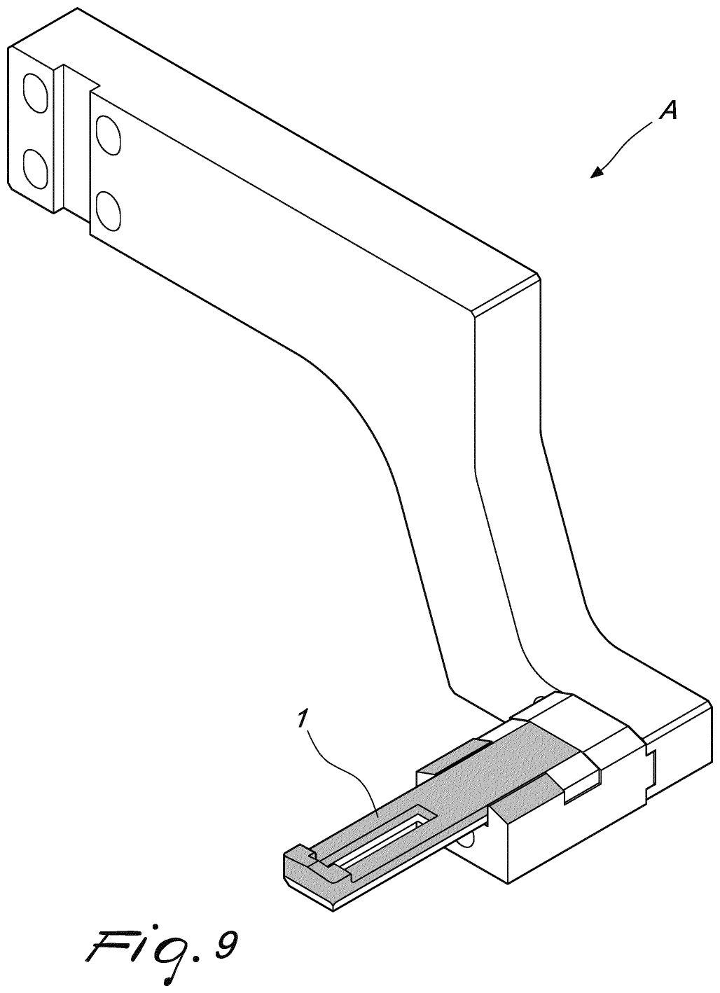

FIG. 8 is a schematic perspective view from above of the mechanical element of FIG. 7;

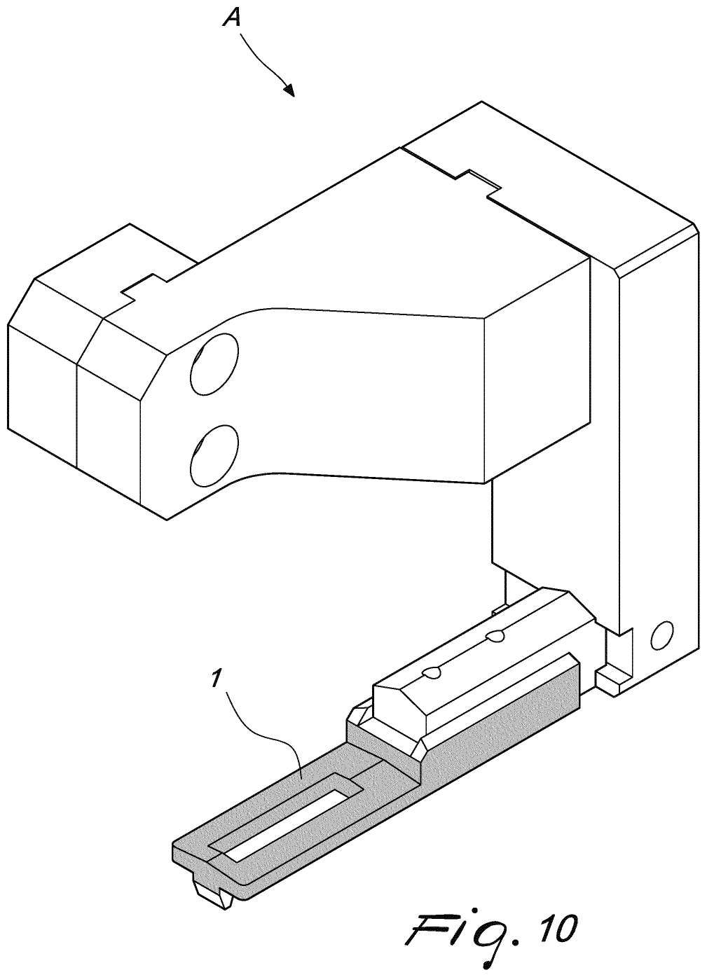

FIG. 9 is a schematic perspective view from below of a sixth embodiment of a mechanical element (in particular a gripping tool) of a welding assembly, provided with the protective coating according to the invention;

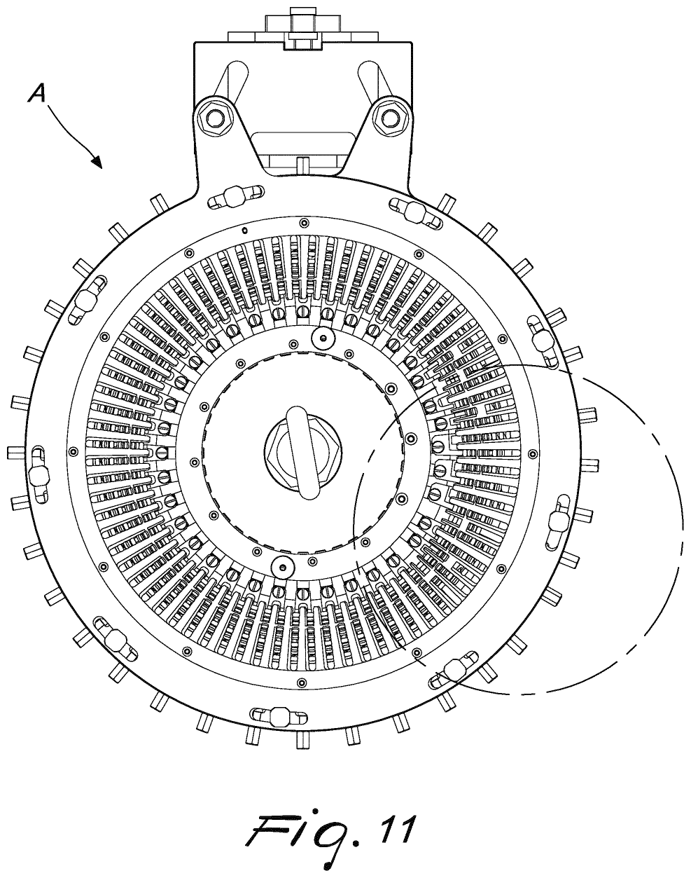

FIG. 10 is a schematic perspective view from below of a seventh embodiment of a mechanical element (in particular a gripping tool) of a welding assembly, provided with the protective coating according to the invention;

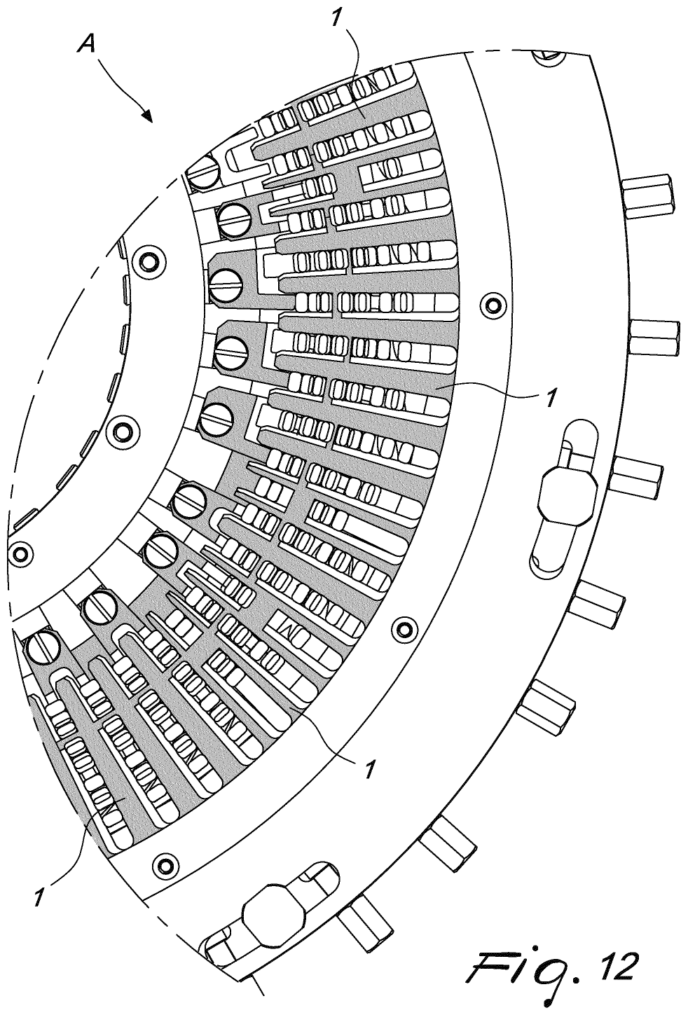

FIG. 11 is a schematic front elevation view of an eighth embodiment of a mechanical element (in particular a gripping tool) of a welding assembly, provided with the protective coating according to the invention;

FIG. 12 is an enlarged view of a detail of FIG. 11.

With particular reference to the figures, the reference numeral 1 generally designates a coating for the protection of mechanical elements A of welding assemblies against weld residues and spatter.

In particular, the present invention is intended for the creation of a protective coating for mechanical elements A that have high mechanical strength: such mechanical elements can therefore be made of metals or metallic alloys, including for the purposes of non-limiting example ferrous alloys, alloys comprising titanium, alloys of nickel, etc.

It should be noted that, preferably, the mechanical elements A of the welding assemblies are made of steel.

To overcome the drawbacks mentioned earlier, the possibility has been evaluated of producing the mechanical elements A that, during their use, are located closer to the points of welding using different technologies (the accompanying figures show specific mechanical elements A of welding assemblies, designed to hold together the components to be welded, of known type which can be subjected to protective measures against spatter and residues of material that may be deposited during the welding operations). Three possible alternatives have been identified: adopting mechanical elements made of steel with laser micro-structuring of the surface; adopting mechanical elements made of steel with surface deposits of various types; using materials other than steel, without further treatments or deposits.

Based on preventive checks conducted during research and development activities, it has been found that options of using laser micro-structuring of the surface of the mechanical elements and of using materials other than steel do not give entirely satisfactory results (for example in relation to the onset of oxidation phenomena, the excessive increase in costs, and the complexity of production).

In particular, these preventive checks have indirectly shown that the embodiment according to the invention, which entails the deposition of a protective coating on the surfaces of the mechanical elements of welding assemblies that are located close to the components to be welded, appears to be the most effective solution, and the easiest to implement, for preventing the phenomenon of adhesion of spatter on the surface of such mechanical elements.

As regards the deposition of a coating on some of the surfaces of such mechanical elements, it has been verified that up to now, such approach had been adopted only to modify the friction coefficient of that surface (with reference to a relative motion with respect to another surface), to increase surface hardness, or to protect the surface from oxidation phenomena.

Dedicated coatings for combating the phenomenon of adhesion of spatter of molten material that can occur during welding processes are not envisaged and/or adopted in the principal known applications. In this technical solution numerous options have been analyzed, including coatings with low-roughness ceramic material, with aluminum oxide (Al₂O₃, also known as alumina), with titanium nitrides (optionally also alloyed with other materials, such as aluminum and/or carbon), with aluminum nitrides (optionally also alloyed with other materials, such as chromium and/or titanium), chromium nitrides, niobium nitrides.

All the tests conducted on these types of coating have shown that they are not suitable to reduce the quantity of spatter of molten metal (according to a preferred solution, molten copper) that solidifies on the surface, adhering thereto.

This preventive experimental phase then led to the identification of the specific type of coating 1 according to the invention and to the process through which to provide it.

The process for the protection of mechanical elements A of welding assemblies against weld residues and spatter is indicated for mechanical elements A made of materials that can withstand the stresses that arise during welding, including metals such as some metallic alloys with high mechanical strength, and designed to hold metallic components to be welded mutually. The process according to the invention is particularly indicated for the protection of mechanical elements A of welding assemblies made of steel.

In particular it should be noted that the process according to the invention can be positively applied to mechanical elements that are designed to hold together metallic components, in particular copper terminals, to be welded to each other: these copper terminals can conveniently be components of a winding (for example of an electric machine, such as a motor, a generator, a transformer) in which circuit continuity will be ensured precisely by the welding together of these ends.

The process according to the invention comprises a first step of powder deposition, such powder comprising aluminum (generally powders of aluminum) on surfaces of the mechanical elements A of the welding assemblies to be protected. The possibility is not ruled out of using aluminum in a form other than powder (according to the specific plasma deposit plant being used), such as for example granules, bars, ingots and the like.

Coating with aluminum powder can be performed using different powder deposition techniques available in the state of the art. According to embodiments, coating with aluminum powder can be performed with thermal deposition techniques, preferably with plasma, i.e. through plasma plating and/or using a plasma arc as the heat source (using the technology known as “plasma transferred arc”). The aluminum powder and the surface of the mechanical element A to be coated are rapidly heated, melted, mixed, spread and solidified, by virtue of the application of the high temperature generated by the plasma arc.

Once the plasma arc is extinguished, the molten metal cools down thus solidifying and forms a coating layer 1 that is perfectly bonded to the surface. By using a plasma arc, the deposition of the coating 1 of aluminum occurs at a high speed, while still ensuring an excellent stability of the layer on the surface and an optimal controllability of the fusion depth.

The coating 1 constituted by the deposited aluminum powder is made through an initial formation of a fusion interface between the surface of the mechanical element A and the melted aluminum powder, resulting in a combination thereof, right at this interface, which ensures a perfect cohesion. The mutual dilution of the material that constitutes the surface (generally steel) and of the aluminum coating is minimal and therefore each material retains its chemical/physical properties.

Once the deposition of the coating 1 (as illustrated in the previous step) is complete, it becomes possible to use the mechanical elements A provided with such layer 1, constituted by the deposit of powders comprising aluminum (generally powders of aluminum) in order to hold specific metallic components together during the welding thereof.

By virtue of the presence of the coating 1, there will be no buildup of welding spatter (spurts, droplets, residues and fragments of molten material that otherwise would solidify and become welded to the surface of the mechanical element A). The coating 1 according to the invention, in fact, by virtue of the fact that it is at least partially constituted of aluminum, ensures that the coating 1 displays a behavior similar to that of aluminum.

Aluminum, in fact, when subjected to testing for adhesiveness to spatter of molten copper, displays an ideal behavior, as its surfaces affected by the spatter of molten copper remain completely clean without any spatter of molten material adhering to them.

It should be noted that the process according to the invention can also advantageously comprise an additional, subsequent step of sulfuric acid anodizing on the surface of said coating 1 performed after the step of applying the aluminum powder coating, which, by way of non-limiting example, could affect a portion of the total thickness of the coating 1, in the order of approximately 8-10 μm.

In particular, such sulfuric acid anodizing will be configured to confer a matt black color on the surfaces to which it is applied. Such coloring and such matt finish are particularly useful because they make it possible for vision systems installed at the welding assembly to acquire images of the components (before and after welding) with high precision, without the treated surfaces being capable of generating noise or corrupting the quality of the acquired image.

It should be noted that the process according to the invention can also profitably comprise a preliminary step of preparing the surfaces of the mechanical elements A of the welding assemblies to be protected which will need to be executed before applying the aluminum powder coating 1. This preliminary step of preparing can in turn be constituted by at least one operation chosen among washing, mechanical machining, laser machining, plasma machining, photoengraving, laser cleaning, plasma cleaning and the like.

The term “washing” means all industrial washing operations that can entail the use of water, solvents, detergents and other chemical agents to eliminate any residue of previous machining and any buildup of material (even of infinitesimal thickness) from the treated surfaces.

All the other forms of preliminary processing mentioned (including laser cleaning and plasma cleaning) on the other hand serve to modify the characteristics of the surface (possibly even just by eliminating the film of superficial oxide present on it) to be treated (even just at the microscopic level) in order to make the surface better adapted to receive the coating 1 comprising aluminum applied using the plasma plating technique.

The possibility is not ruled out that such operations might even be superfluous in some cases.

It should further be noted that the step of applying the powder deposition, wherein such powder comprises aluminum (generally aluminum powder) on surfaces of the mechanical elements A of the welding assemblies to be protected can positively be configured to confer them with a surface roughness not greater than 0.6 μm, preferably close to 0.4 μm or, in any case, lower than that value.

A low surface roughness of the coating 1 according to the invention makes it possible to minimize the extent of the surface that will come into contact with the molten metal (spurts, or fragments, or spatter), thus reducing the risk of these being able to adhere to the surface.

This roughness value can be ensured directly via the aluminum powder coating 1 deposition, although the possibility is not ruled out of performing (conventional) surface machining to impose the desired surface roughness value.

It should be noted that the surfaces of the mechanical elements A on which the aluminum powder deposition is performed are preferably constituted by a ferrous alloy, in particular steel.

The coating 1 obtained through the process described, being constituted at least in part by aluminum, ensures a high tolerance of and resistance to high temperatures: preferably, the coating 1 should be able to withstand a temperature of the order of 1,800° C. for at least 0.4 seconds without undergoing any kind of damage (these values refer in particular to the process of welding copper components and to the phenomenon of spatter that is typical of that material).

The coating 1 made with the process according to the invention can furthermore be of the passivation type, or optionally it can be subjected to passivation by means of a specific process.

Passivation is a chemical process that enables a metal to better withstand the action of corrosive agents. The result of the passivation of metals is the formation of a thin, dense and uniform film that protects the metal from attack by oxidizing agents. The passivating film can render the metal completely protected, by blocking the chemical processes of corrosion or delaying them extremely. This process, which in nature would be unpredictable and slow, can be controlled and accelerated to meet industrial timescales using specific chemical treatments. The most suitable treatment can be chosen based on the environment in which the metal is arranged, taking into account the effect of the corrosive agents, of the temperature and of the humidity of the environment. In particular, sulfuric acid anodization is an excellent electrolytic passivation process that is preferably used for the aluminum coating. Alternatively other chemical processes may be used.

The present invention extends its protection to a coated mechanical element A designed to hold metallic components to be subjected to welding. This element A comprises a surface, which is at least partially covered with a coating 1; said coating 1 is constituted by aluminum powder deposited on the surface of the element A so as to create a protection of the mechanical element A against weld residues and spatter.

The coating 1 can advantageously be obtained by way of a deposition method available in the state of the art. According to some embodiments, the deposition method is of the thermal type, preferably of a type chosen from a plasma deposition method, also known as plasma plating, a plasma transferred arc technique, and the like.

Furthermore, the coating 1 can conveniently have a thickness comprised between 0.1 μm and 1000 μm.

In more detail, a portion of the coating 1 can profitably be further subjected to an anodizing process applied on the external surface of the coating 1. In such case the anodized portion of the coating 1 will be distributed in depth on an anodizing thickness that is less than the thickness of the entire coating 1. It is useful to note that there is no exact ratio between the thickness of the coating and the thickness of the anodized layer, and this is despite the fact that it has been verified that in order to successfully anodize 20 μm of thickness, it is necessary for the underlying coating of powders of aluminum be at the maximum obtainable values, so as to effectively have a sufficient quantity of material remaining to be oxidized.

It is further emphasized that the process of anodizing can positively be of the sulfuric acid anodizing type; in such case, the surface of the anodized coating 1 will be matt black in color.

The coating deposited on the element A can be advantageously performed so as to leave a surface roughness not greater than 0.6 μm, preferably close to 0.4 μm.

Finally it should be noted that the surfaces of the mechanical elements A on which the aluminum powder coating 1 is applied can conveniently be made of a ferrous alloy, in particular steel.

The present invention can therefore also relate to a coating 1 for the protection of mechanical elements A against weld residues and spatter.

In particular the coating 1 according to the invention will be of the type suitable to be applied on mechanical elements A made of hard materials and designed to hold metallic components to be welded together (by way of example: clamping copper wire terminals that need to be welded in order to close an electrical circuit and/or to complete an electrical winding).

It should be noted that the mechanical elements will preferably be made of steel. In particular it is possible to use high-strength steel (such as for example the material designated W360 sold by the Bohler company) which for example can comprise approximately 0.5% carbon, approximately 0.2% silicon, approximately 0.25% manganese, approximately 4.5% chromium, approximately 3% molybdenum and approximately 0.6% vanadium. The possibility is not ruled out however of adopting different types of steel or other metallic alloys or other materials, and in particular it is possible to use stainless steel.

Such coating 1 comprises, according to the invention, at least one layer at least partially constituted by aluminum, deposited on at least one of the surfaces to be protected of the mechanical elements A of the welding assemblies.

It should be noted that the mechanical elements A can be fully coated with the coating 1, or only some surfaces may be selected (those surfaces facing the components that will be subjected to being welded together) which are more prone to being struck by welding spatter. The accompanying figures show embodiments in which the coating 1 is present only on some surfaces, in order to make this expediency clear: the possibility is not ruled out however of covering the mechanical element A entirely.

As already explained in detail previously, the at least one layer that will constitute the coating 1 according to the invention can conveniently be deposited on the at least one surface of the mechanical element A, and will have a thickness comprised between 0.1 μm and 1000 μm.

It should further be noted that the at least one layer at least partially constituted by aluminum can profitably be of the anodized type, with an anodizing thickness comprised between 5 μm and 20 μm (preferably between 8 μm and 10 μm).

It should also be noted that such anodizing of the layer can be of the sulfuric acid type, matt black in appearance: this appearance has a positive influence in that it enables the coating 1 not to generate optical noise (such as reflections) and it increases the contrast for any vision systems that are tasked with monitoring the components to be welded in the welding assembly.

Finally, it should be noted that, as previously explained above, the at least one layer can advantageously have a surface roughness not greater than 0.6 μm, preferably close to 0.4 μm or lower than that value. As explained previously, a low surface roughness reduces the area of the surface on which any welding spatter impacts, thus minimizing the risk of an adhesion thereof to the coating 1.

The coating 1 according to the invention is particularly advantageous because it can be performed on steel (a material that constitutes substantially all the mechanical elements, including mechanical apparatuses, of welding assemblies, in particular grippers and clamps designed to hold the components to be welded) and because, being at least partially constituted by aluminum, makes it possible to minimize the risk of adhesion of spurts or fragments or spatter of molten material (with particular reference to molten copper).

The coating 1 according to the invention, furthermore, can be reprocessed after being deposited and therefore it can be subjected to processing of any kind, for example aimed at modifying the surface roughness to make it as low as possible (for example with a value of approximately 0.4 μm or lower).

The coating 1 according to the invention will be particularly adapted to withstand, without undergoing any kind of damage, very high temperatures (such as for example the temperatures of molten copper) for a time that is sufficient to ensure that the heat is dissipated (for example the coating 1 according to the invention will positively be capable of withstanding approximately 1800° C. for approximately 0.4 seconds, without undergoing any damage or any degradation).

The surface of the coating 1 according to the invention will be subjected to passivation so as to offer stable characteristics and be chemically and physically as similar as possible to the surface of a sheet of anodized aluminum (which ensures an exceptional reduction of adhesion, to the point of elimination, of spurts and spatter of molten material, in particular molten copper).

The application of the process according to the invention, the coated mechanical element A and the adoption of the coating 1 according to the invention therefore ensure the following:
the useful life of the mechanical elements A is extended;
   the time intervals that elapse between successive ordinary maintenance operations are extended (cleaning is generally necessary quite often, owing to the spatter of molten material, in particular copper, which adheres to the surfaces of mechanical elements A that lack protection);
the stability of the process of welding components is improved (in particular for copper terminals of electric conductors that constitute an electrical winding) because the equipment is kept cleaner;
the quality is improved of the images acquired by the artificial vision system associated with the welding assembly, which in this manner makes it possible to better and more rapidly recognize the shapes of components yet to be welded and of components which have been welded.

Advantageously the present invention solves the above mentioned problems by providing a process for the protection of mechanical elements A of welding assemblies against weld residues and spatter that makes it possible to avoid frequent extraordinary maintenance operations that would require a machine shutdown.

Conveniently the process 1 according to the invention makes it possible to use mechanical elements A constituted by materials of high mechanical strength and high melting and softening temperatures (higher than or equal to that of the components to be welded).

Profitably the process according to the invention is adapted to provide a coating 1 that ensures that the mechanical element A that comprises it maintains dimensions that are substantially similar to the initial ones, even after the deposition of such coating 1. The protection against the adhesion of spatter of molten material (in particular molten copper) is in fact ensured even if the thickness of the coating 1 is very slender (close to the lower limit previously mentioned above).

Positively the process 1 according to the invention increases the service lifetime of the mechanical elements A that comprise the coating 1 deposited using the process.

Conveniently the coating 1 for the protection of mechanical elements A of welding assemblies against weld residues and spatter according to the invention minimizes the periodic maintenance interventions on the mechanical elements that comprise it.

Usefully the coating 1 according to the invention ensure that excellent quality of the welds performed is maintained, even for extremely long operating times.

Positively the process and the coating 1 according to the invention are relatively easily and practically implemented and at low cost: these characteristics make the process and the coating 1 according to the invention innovative and safe in use.

The invention, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. 102022000014680 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-14. (canceled)

15. A process for protection of mechanical elements of welding assemblies against weld residues and spatter, for mechanical elements designed to hold metallic components to be welded together, comprising the steps of:
depositing aluminum powder on surfaces of the mechanical elements of said welding assemblies to be protected so as to obtain a coating on said mechanical elements;
using said mechanical elements provided with said coating, in welding operation, wherein said coated mechanical elements hold metallic components together so that they are welded to each other.

16. The process according to claim 15, wherein the step of depositing aluminum powder is performed by a method of a type chosen from plasma deposition, known as plasma plating, plasma transferred arc technique, and the like.

17. The process according to claim 15, further comprising a further step of performing sulfuric acid anodizing on the surface of said coating after the step of depositing aluminum powder.

18. The process according to claim 17, wherein said sulfuric acid anodizing is performed so as to confer a matt black color to the surfaces to which the sulfuric acid anodizing is applied.

19. The process according to claim 15, further comprising, before the step of depositing aluminum powder, a step of preparing the surfaces of the mechanical elements of said welding assemblies to be protected, which is constituted by at least one operation chosen among washing, mechanical machining, laser machining, plasma machining, photoengraving, laser cleaning, plasma cleaning, and the like.

20. The process according to claim 15, wherein said step of depositing aluminum powder on surfaces of the mechanical elements of said welding assemblies to be protected is performed so as to confer a surface roughness not greater than 0.6 μm, preferably not greater than 0.4 μm, on said surfaces.

21. The process according to claim 15, wherein the surfaces of said mechanical elements on which said step of depositing aluminum powder is performed are made of ferrous alloy, in particular steel.

22. A coated mechanical element for holding metallic components to be subjected to welding, said coated mechanical element comprising a surface, which is at least partially coated with a layer of coating, wherein said layer of coating is constituted by aluminum powder being deposited on said surface so as to create a protection of the mechanical element against weld residues and spatter.

23. The coated mechanical element according to claim 22, wherein said layer of coating is obtained by means of a method of type chosen from a plasma deposit method, also known as plasma plating, a plasma transferred arc technique, and the like.

24. The coated mechanical element according to claim 22, wherein said layer of coating has a thickness comprised between 0.1 μm and 1000 μm.

25. The coated mechanical element according to claim 22, wherein a portion of said layer of coating is further subjected to an anodizing process, applied on an external surface of said layer of coating to obtain a portion of anodized coating, and wherein said portion of anodized coating is distributed in depth on an anodizing thickness that is less than a thickness of the entire layer of coating.

26. The coated mechanical element according to claim 25, wherein said anodizing process is of a sulfuric acid anodizing type and wherein a resulting surface of said anodized coating is of matt black color.

27. The coated mechanical clement according to claim 22, wherein the deposited layer coating is made so as to leave a surface roughness not greater than 0.6 μm, preferably close to 0.4 μm.

28. The coated mechanical clement according to claim 22, wherein the surfaces of said mechanical elements on which said aluminum powder coating is applied are made of ferrous alloy, in particular steel.
